(19) United States
(12) Patent Application Publication
(10) Pub. No.: US 2017/0066884 A1
(43) Pub. Date: Mar. 9, 2017

(54) RESIN TAPPING MEMBER AND METHOD OF SEPARATING AND RECOVERING POLYMER FROM POLYMER-CONTAINING LIQUID USING SAME

(71) Applicant: Kureha Corporation, Tokyo (JP)

(72) Inventors: KOHTA KOICHI, Tokyo (JP); MICHIHISA MIYAHARA, Tokyo (JP); YOSHIHIRO ICHINOSE, Tokyo (JP); MASAO SAKAI, Tokyo (JP); YOSHIAKI TOMIOKA, Tokyo (JP)

(21) Appl. No.: 15/121,955

(22) PCT Filed: Feb. 27, 2015
(86) PCT No.: PCT/JP2015/055895

§ 371 Date: Aug. 26, 2016

(30) Foreign Application Priority Data
Feb. 28, 2014 (JP) 2014-039559

(51) Int. Cl. C08G 75/0281; B07B 1/06; C08F 110/02; B01D 33/03; B01D 35/20; C08F 110/06; B07B 1/54; B07B 1/28

(52) U.S. Cl. CPC C08G 75/0281; B07B 1/54; B07B 1/06; B07B 1/284; B01D 33/0392; B01D 35/20; C08F 110/06; C08F 110/02

(57) ABSTRACT

A resin tapping member used for a method of separating and recovering that enables a polymer to be separated and recovered from a polymer-containing liquid during or after a polymerization reaction at a high quality, high efficiency, and high processing capacity. The resin tapping member for preventing clogging of a screen is used in separating and recovering a polymer obtained by a polymerization reaction in a solvent. The resin tapping member has a weight reduction percentage of 3 wt. % or less after continuous separating and recovering of a polymer from a polymer-containing liquid for 48 hours.

### TECHNICAL FIELD

The present invention relates to a resin tapping member and a method of separating and recovering a polymer obtained by a polymerization reaction in a solvent, whereby during or after the polymerization reaction, a polymer is separated and recovered using a vibrating sieve device to screen the polymer from a polymer-containing liquid at a high quality, high efficiency, and high processing capacity. “High quality” refers to obtaining a polymer without degrading its quality. “Highly efficient” refers to reducing cost associated with cooling of the polymer-containing liquid and the like. “High processing capacity” refers to the rapid processing of great volumes.

### BACKGROUND ART

Plastics such as polyvinyl chloride (hereinafter abbreviated as “PVC”), methyl methacrylate-butadiene-styrene (hereinafter abbreviated as “MBS”), polyarylene sulfide (hereinafter abbreviated as “PAS”), and the like are commonly used today. A method typically employed to produce such plastics includes the steps of polymerizing in a solvent, separating and recovering a polymer from a polymer-containing liquid after the step of polymerizing, and drying the separated and recovered polymer.

The step of polymerizing involves synthesizing a polymer with a desired structure and characteristics. The step of separating and recovering, i.e. post-processing, involves separating and recovering the polymer obtained by the step of polymerizing in an efficient manner without degrading the quality. From a standpoint of continuous operation, there is a demand for the step of separating and recovering to have a capacity greater than the step of polymerizing (pre-step) and the step of drying (post-step), and to have a good balance with the capacities thereof. Accordingly, there is a demand for instruments and devices used in the step of separating and recovering to have the capabilities of maintaining the quality of the polymer, being highly efficient, and having high processing speed and volume.

There are various known methods of separating and recovering a polymer from a polymer-containing liquid during or after a polymerization reaction. Typical methods include a filtration method using a filter (for example, a horizontal belt vacuum filter), a centrifugal separation method utilizing centrifugal force (for example, a centrifugal separator), a separation method using a vibrating screen (for example, a vibrating sieve device), and the like. PVC, for example, is separated and recovered from a polymer-containing liquid after suspension polymerization using a centrifugal separator. MBS is separated and recovered by introducing a polymer-containing liquid (coagulant solution) obtained by adding an inorganic salt or inorganic acid to the emulsion after polymerization to a horizontal belt vacuum filter.

WO/2006/027985 (Patent Document 1) describes technology that uses a vibrating sieve device. Specifically, it describes cooling to room temperature a polymeric slurry (polymer-containing liquid) obtained by polymerization of a sulfur source and a dihalo aromatic compound in a polar organic solvent, and screening using a sieve device provided with a horizontal vibrating screen with sieve openings of 105 m.

Additionally, although not a method of separation and recovery from a polymer-containing liquid during or after a polymerization reaction, Japanese Unexamined Patent Application Publication No. 2010-69354 (Patent Document 2) describes a method of classifying dried particles in which a vibrating sieve device provided with tapping balls (excitation elements) is used, the vibrating sieve device being configured to tap the tapping balls.

### CITATION LIST

### Patent Literature

Patent Document 1: WO/2006/027985

Patent Document 2: Japanese Unexamined Patent Application Publication No. 2010-69354A

### SUMMARY OF INVENTION

### Technical Problem

Separating and recovering using a centrifugal separator is characterized by its convenience. However, it is a batch method of separating and recovering and thus problems associated with making the separating and recovering continuous and improving the process capacity exist. Moreover, problems in quality arise such as the amount of liquid contained in the wet cakes of each batch differing, and the increased likelihood of the polymer granules being deformed or broken by the centrifugal forces.

Separating and recovering using a horizontal belt vacuum filter with a filter cloth is a continuous method, and thus is advantageous in that the processing capacity can be comparatively easily increased depending on operating conditions and the like. However, as vacuum suction is performed, polymer granules are likely to clog the filter cloth, which is a large problem in processing.

Separating and recovering using a vibrating sieve device is a continuous method, and, moreover, because the screen is vibrated, clogging can be effectively prevented to a degree. As such, it is an advantageous method, though to-date the anti-clogging has been insufficient.

Furthermore, as described in Patent Document 1, the polymer-containing liquid subject to separation and recovery must be cooled to room temperature, and this causes problems from the standpoint of efficiency and processing capacity.

In the production of plastics, the demand for high quality, high efficiency, and high processing capacity (high manufacturability) has been great of late, and, enhancement or development of separating and recovering instruments or devices capable of meeting such demands even in the step of separating and recovering present a significant challenge.

The present inventors, in light of such, set out to increase the efficiency by introducing the polymer-containing liquid to a separating and recovering instrument or device during or after a polymerization reaction at a temperature close to the polymerization reaction temperature, and set out to increase processing capacity by imparting more effective vibrations to the screen of the vibrating sieve device to prevent clogging to a greater degree.

In the case of many plastics, the polymerization reaction temperature is typically in a range of 50 to 300° C. By separating and recovering a polymer from a polymer-containing liquid adjusted to a temperature as close as possible to the polymerization reaction temperature and less than the glass transition temperature, melting point, and melt crystallization temperature of the plastic, i.e. a temperature in a range of 30 to 230° C., when compared to the separating and recovering from the polymer-containing liquid at room temperature described in Patent Document 1 for example, the time needed for cooling of the polymer-containing liquid is greatly reduced, the cost for cooling is reduced, and the like, thus great strides can be made toward greater efficiency.

However, introducing a polymer-containing liquid to a vibrating sieve device at a temperature in the range of 30 to 230° C. results in the polymer granules clumping together more or stick to the screen more due to that the polymer granules has softened more than when introduced at room temperature, thus increasing the chance of clogging. In other words, enhancements to the processing capacity may be inhibited.

From this, the present inventors arrived at a clogging prevention means of imparting to the screen tapping (excitation) via tapping balls (excitation elements made of rubber) instead of horizontal and vertical vibrations. The present inventors then began to look into whether the target problems could be solved by combining this idea with a means of increasing efficiency by processing the polymer-containing liquid at high temperatures.

The two measures described above were found to be advantageous in achieving the target object. However when this method was employed for continuous separating and recovering of a polymer from a polymer-containing liquid with high acidity or alkalinity at a temperature of 30 to 230° C. over an extended period of time, the (rubber) tapping balls quickly deteriorated. This caused frequent troubles such as a reduction in weight of the (rubber) tapping balls because of wear in the (rubber) tapping balls caused by the shock or friction between the tapping balls and constituent members of the vibrating sieve device such as the screen and perforated plate, the shock or friction between the tapping balls, or the like.

Additionally, minute particles created by such shock or friction contaminated the separation and recovery target as impurities. This new problem affected tapping during the separating and recovering of a polymer from a polymer-containing liquid with high acidity or alkalinity at high temperatures.

Through diligent research into this new problem, the present inventors has succeeded in providing a method of separating and recovering using a separating and recovering instrument or device having high efficiency, excellent processing capacity, and that does not result in quality degraded from the target quality. This method employs the use of specific resin tapping members with heat resistance, chemical resistance, and wear resistance. Thus, clogging of the screen when separating and recovering is performed continuously for an extended period of time can be prevented and the new problem described above of weight reduction caused by shock or wear between the tapping members or a tapping member and a constituent member of the vibrating sieve device such as the screen, and contamination of the product by parts produced by this weight loss can be solved.

### Solution to Problem

According to the present invention, provided is a resin tapping member for preventing clogging of a screen used in separating and recovering a polymer obtained by a polymerization reaction in a solvent, the resin tapping member having a weight reduction percentage of 3 wt. % or less after continuous separating and recovering of a polymer from a polymer-containing liquid for 48 hours.

Additionally, according to the present invention, provided is a resin tapping member, wherein a sample of the resin that forms that resin tapping member has a tensile strength retention percentage of 98% or greater after 1000 hours of immersion in a liquid chemical.

Additionally, according to the present invention, provided is a resin tapping member, wherein the resin tapping member includes at least one resin selected from the group consisting of polyamide, polyimide, polyether ether ketone, polymethylpentene, high density polyethylene, ultra high molecular weight polyethylene, polypropylene, and polyarylene sulfide.

Additionally, according to the present invention, provided is a resin tapping member, wherein the resin tapping member includes at least one resin selected from the group consisting of polyether ether ketone, polymethylpentene, polypropylene, and polyarylene sulfide.

Additionally, according to the present invention, provided is a resin tapping member, wherein the resin tapping member has a form of a cube, a rectangular parallelepiped, a plate, a cylinder, a tube, a donut, a cone, or a sphere.

Additionally, according to the present invention, provided is a resin tapping member, wherein the resin tapping member has a form of a tube.

Additionally, according to the present invention, provided is a method of separating and recovering a polymer obtained by a polymerization reaction in a solvent, the method comprising the step of separating and recovering a polymer from a polymer-containing liquid during or after a polymerization reaction by screening using a vibrating sieve device, wherein the vibrating sieve device includes the resin tapping member for preventing clogging of a screen.

Additionally, according to the present invention, provided is a method of separating and recovering, wherein the polymer contains sulfur in a backbone, and a temperature of the polymer-containing liquid is from 30 to 230° C. in screening.

Additionally, according to the present invention, provided is a method of separating and recovering, wherein the polymer is polyarylene sulfide.

Additionally, according to the present invention, provided is a vibrating sieve device for use in the method of separating and recovering, the vibrating sieve device comprising a screen, a perforated plate disposed below the screen, and a resin tapping member disposed between the screen and the perforated plate; wherein

vibrations of the vibrating sieve device cause the resin tapping member to tap, this tapping preventing clogging of the screen.

Additionally, according to the present invention, provided is a vibrating sieve device, wherein (K−H)/H is from 0.1 to 1, where H is a height of the resin tapping member and K is an interval between the screen and the perforated plate.

### Advantageous Effects of Invention

For separating and recovering a polymer from a polymer-containing liquid during or after a polymerization reaction by screening, the vibrating sieve device is used. The vibrating sieve device includes the resin tapping member of the present invention for preventing clogging of the screen. This configuration is effective in preventing clogging of the screen, weight reduction caused by shock or friction between tapping members or a tapping member and a constituent member of the vibrating sieve device such as the screen, contamination of the product by parts produced by this weight reduction, and the like. Moreover, the separating and recovering can be performed on a high temperature polymer-containing liquid. As a result, separating and recovering a polymer can be performed at a high quality, high efficiency, and high processing capacity.

### BRIEF DESCRIPTION OF DRAWINGS

FIG. 1 is a schematic cross-sectional view of a circular vibrating sieve device.

FIG. 2 is a schematic view of a tubular resin tapping member.

### DESCRIPTION OF EMBODIMENTS

1. Polymerization Reaction

1-1. Polymer

In the method of separating and recovering a polymer from a polymer-containing liquid during or after the polymerization reaction in a solvent by screening using a vibrating sieve device provided with a resin tapping member for preventing clogging of the screen (hereinafter abbreviated as “vibrating sieve device” or “vibrating sieve device of the present invention”), the target polymer may be any known polymer and there are no special limitations applied thereto.

The target polymers may be of the groups of plastics widely used such as engineering plastics and super engineering plastics. However, examples of polymers that can be used to fully realize the effect of the present invention include a PVC; styrene based polymers such as a polystyrene, acrylonitrile-styrene polymer, acrylonitrile-butadiene-styrene polymer, and MBS; fluorine based polymers such as a polyvinylidene fluoride and polyvinyl fluoride; polyesters such as a polyethylene terephthalate and polybutylene terephthalate; polyamides such as a nylon 6, nylon 6-6, and nylon 12; a polycarbonate; and polymers with sulfur in the backbone such as a PAS, poly(arylene thioether-ketone), polysulfone, polyethersulfone. The polymer is preferably a PVC, a fluorine based polymer, or a polymer with sulfur in the backbone. The polymer is more preferably a PAS, poly(arylene thioether-ketone), polyvinylidene fluoride, polysulfone, or polyethersulfone. The polymer is even more preferably a PAS represented by polyphenylene sulfide (hereinafter abbreviated as “PPS”). In other words, a PAS is a suitable polymer to be separated and recovered by being screened using the vibrating sieve device of the present invention.

1-2. Polymerization Reaction in Solvent

According to the method of separating and recovering using a vibrating sieve device of the present invention, the polymer-containing liquid for separating and recovering a polymer is a polymer-containing liquid in which the polymerization reaction is in progress or completed and contains the polymer obtained by the polymerization reaction in the solvent.

Various kinds of polymerization reaction in a solvent can be used to obtain the polymer and the polymerization reaction appropriate for the target polymer can be selected. Polymerization reaction can be suitably performed using suspension polymerization, emulsion polymerization, solution polymerization, precipitation polymerization, slurry polymerization, and the like.

Hereinafter, an example of a polymerization reaction for producing a PAS will be explained.

A PAS is typically obtained using a known method of obtaining a granular PAS.

An example of a method of obtaining a PAS via a polymerization reaction includes the following steps (1) and (2).

(1) Preparing Step

The preparing step (1) includes preparing a mixture containing an organic amide solvent, a sulfur source containing an alkali metal hydrosulfide or an alkali metal hydrosulfide and an alkali metal sulfide, an alkali metal hydroxide, water, and a dihalo aromatic compound. The amounts of the components per 1 mol of sulfur source are adjusted to the following ranges:

alkali metal hydroxide, from 0.95 to 1.15 mol;

water, from 0.01 to 2 mol;

dihalo aromatic compound, from 0.95 to 1.15 mol;

organic amide solvent, from 0.1 to 10 kg. The organic amide solvent is preferably N-methyl-2-pyrrolidone (hereinafter abbreviated as “NMP”), N-methyl-ε-caprolactam, 1,3-dialkyl-2-imidazolidinone, or the like. The alkali metal hydrosulfide and/or alkali metal sulfide sulfur source is preferably sodium hydrosulfide, sodium sulfide, or the like. The dihalo aromatic compound is preferably dichlorobenzene, dibromobenzene, or the like.

(2) Polymerizing Step

The polymerizing step (2) includes a pre-stage polymerization step (i) in which the prepared mixture is heated at a temperature of 170 to 270° C. for 0.5 to 15 hours, continuing the polymerization reaction until the conversion ratio of the dihalo aromatic compound is from 75 to 99%; and a post-stage polymerization step (ii) in which, after the pre-stage polymerization, per 1 mol of the sulfur source, greater than 2 mol and 10 mol or less of water is added to the polymerization reaction mixture, and in a liquid-liquid phase separation state, the polymerization reaction is continued at a temperature of 240 to 290° C. for 0.5 to 10 hours.

The reaction solution after polymerization, i.e. liquid containing PAS, can be obtained as a slurry.

Additionally, before the preparing step (1), a dehydration step may be performing in which a liquid mixture containing the sulfur source, which contains an alkali metal hydrosulfide or an alkali metal hydrosulfide and an alkali metal sulfide, and, per 1 mol of the sulfur source, from 0.9 to 1.2 mol of an alkali metal hydroxide, and from 0.1 to 10 kg of an organic amide solvent is heated at a temperature of 100 to 290° C. for 0.5 to 25 hours to distill the water from the liquid mixture out of the reaction system, and thus adjusting the water content to that of the preparing step (1).

1-2-1. Solvent

According to the method of separating and recovering of the present invention, the polymer-containing liquid for separating and recovering is obtained via a polymerization reaction in a solvent and is a liquid mixture of a polymer and a solvent, a liquid solution, an emulsion, or the like, an example of which is a mixture for polymerization reaction in a solvent containing a monomer for forming the polymer.

In this case, solvents typically used in the various polymerization reactions can be used. Such examples include water, ketone based compounds (such as acetone, methyl ethyl ketone), alcohol based compounds (such as methyl alcohol), benzene based compounds (such a benzene and toluene), chloride based compounds (such as chlorobenzene), oxygen based compounds (such a dioxane), organic amide compounds (such as dimethylformamide), and the like. However, the solvent is not limited to these solvents and can be appropriately chosen depending on the target polymer, polymerization reaction, polymerization conditions, and the like.

1-2-2. Polymerization Temperature and Polymerization Duration

The polymerization temperature of the polymerization reaction employed to obtain the polymer is typically 350° C. or less, preferably from 50 to 300° C., and more preferably from 60 to 290° C.

At present, the polymerization temperature employed in the polymerization reaction of many commonly used polymers is in the above ranges. A polymerization temperature higher than 350° C. results in cases of increased capacity (manufacturing capacity) in the polymerizing step and also detrimental cases.

Additionally, the polymerization duration for the polymerization reaction is not limited to a particular duration and may be from 0.5 to 50 hours, preferably from 1 to 30 hours, and more preferably from 1.5 to 20 hours.

Typically, when the polymerization temperature is high, the polymerization duration is short; and when the polymerization temperature is low, an extended period of time is needed for the polymerization reaction. Accordingly, the polymerization temperature and the polymerization duration may be decided depending on the polymer and the polymerization reaction.

2. Method of Separating and Recovering

The method of separating and recovering of the present invention is a method of separating and recovering a polymer obtained via a polymerization reaction in a solvent wherein during or after the polymerization reaction, the polymer is separated and recovered from a polymer-containing liquid via screening using a vibrating sieve device. The vibrating sieve device is provided with the resin tapping member of the present invention for preventing clogging of the screen.

2-1. Polymer-Containing Liquid

The polymer-containing liquid used in the separating and recovering of the present invention is a polymer-containing liquid obtained during or after a polymerization reaction in a solvent and is a liquid mixture containing a polymer in a liquid, i.e. the solvent. Additionally, the polymer-containing liquid may be a liquid mixture of a polymer and a solvent, a liquid solution, an emulsion, and the like having undergone a washing step provided if necessary.

The polymer contained in the polymer-containing liquid during or after the polymerization reaction is not limited to a particular form and may have the form of a liquid, a mass, a slurry, a granule, a particle, and the like. Granules are preferable and particles are more preferable to afford high efficiency and processing capacity to the separating and recovering.

Accordingly, the polymer-containing liquid is preferably a polymer-granule-containing liquid and more preferably a polymer-particle-containing liquid.

There are various ways in which the polymerization reaction in a solvent can be performed depending on the characteristics of the monomer, polymer, solvent, and the like; the polymerization method; the polymerization conditions; and the like. The reaction solution during or after the polymerization reaction is typically in a solid-liquid mixed state such as a slurry or a suspension, an emulsion state, or a liquid solution state.

The reaction solution used in the method of separating and recovering of the present invention may be a reaction solution in one of the states described above. Other examples of reaction solutions that can be used as the polymer-containing liquid of the present invention include reaction solutions inherently in a solid-liquid mixed state, or reaction solutions to which processes are performed on including reaction solutions in an emulsion state to which, for example inorganic salt or inorganic acid is added to obtain a coagulant solution (solid-liquid mixed state), reaction solutions in a liquid solution state in which the polymer is precipitated in the presence of a poor solvent to change it to a solid-liquid mixed state, and the like.

The concentration of the polymer contained in the polymer-containing liquid is typically from 5 to 60 wt. %, preferably from 7 to 55 wt. %, more preferably from 9 to 50 wt. %, and even more preferably from 10 to 48 wt. %. The concentration of the polymer is an important factor affecting the processing capacity of the vibrating sieve device in separating and recovering using the vibrating sieve device of the present invention.

When the polymer-containing liquid is a polymerization reaction liquid, the method of separating and recovering of the present invention provided can include the polymer-containing liquid being neither diluted nor concentrated. However, to increase the separating and recovering performance, facilitate washing of the polymer, and other such objects, the solvent used in the polymerization reaction and/or other solvents can be diluted.

The solvent is preferably water, organic amide solvent, ketone, alcohol, and the like.

The polymer-containing liquid may be concentrated. Additionally, one portion of the solvent can be removed by operations such as fractionation, distillation, and the like.

In such manners, the efficiency and processing capacity of the separating and recovering can be further increased via dilution and concentration.

From the standpoint of manufacturing conditions and quality requirements of the product, the concentration of the polymer after the polymerization reaction is typically from 10 to 35 wt. %. by increasing the concentration by distilling the solvent, i.e. water, or diluting by adding solvent or the like, the concentration of the polymer contained in the polymer-containing liquid is preferably from 5 to 60 wt. %.

A polymer with a concentration of 60 wt. % or greater becomes difficult to separate and recover. When 5 wt. % or less, processing capacity becomes problematic.

2-2. Temperature of Polymer-Containing Liquid

In the present invention, the temperature of the polymer-containing liquid upon separating and recovering the polymer from a polymer-containing liquid during or after the polymerization reaction by screening using a vibrating sieve device provided with a resin tapping member is from 30 to 230° C.

Polymerization temperature for typically known polymers is typically 350° C. or lower, preferably from 50 to 300° C., and more preferably from 60 to 290° C. Upon separation and recovery, the closer the temperature of the polymer-containing liquid is to the polymerization temperature, the more the efficiency of the separating and recovering is increased, thus making this a preferable aspect.

The concentration of the polymer contained in the polymer-containing liquid is typically from 5 to 60 wt. %, preferably from 7 to 55 wt. %, more preferably from 9 to 50 wt. %, and even more preferably from 10 to 48 wt. %.

In separating and recovering a polymer, taking into account thermal characteristics such as the glass transition temperature, melting point, and melt crystallization temperature and setting the temperature as high as possible without reaching these values is important.

In the present invention, the temperature of the polymer-containing liquid when screened after being introduced into the vibrating sieve device provided with the resin tapping member is preferably from 40 to 200° C., more preferably from 45 to 190° C., even more preferably from 48 to 185, and yet even more preferably from 50 to 180° C.

By separating and recovering at such temperatures together with using the resin tapping member, a synergistic effect on efficiency and processing capacity can be obtained. When the temperature of the polymer-containing liquid is less than 30° C., time and costs are needed to cool the polymerization reaction liquid during or after the polymerization reaction, and thus makes it difficult to increase the efficiency of the separating and recovering. When the temperature of the polymer-containing liquid is greater than 230° C., the screen experiences excessive clogging by polymer particles during separating and recovering or polymer particles clump together resulting in problems such as increased wear and deformation of the resin tapping members.

2-3. Vibrating Sieve Device Arrangement

The method of separating and recovering of the present invention is a method of separating and recovering a polymer from a polymer-containing liquid during or after a polymerization reaction by screening using a vibrating sieve device of the present invention. The vibrating sieve device is used in the separating and recovering step in between the polymerizing step and the drying step in which a polymer is separated and recovered (hereinafter, written as “polymerizing step→separating and recovering using the vibrating sieve device of the present invention→drying step”). In other words, the separating and recovering step using the method of separating and recovering of the present invention is arranged between the polymerizing step in which a polymer-containing liquid, i.e. polymerization reaction liquid, is obtained, and the drying step in which the separated and recovered polymer is dried.

Additionally, in the method of separating and recovering of the present invention, when arranged between the polymerizing step and the drying step, a plurality of vibrating sieve devices can be arranged. The plurality of vibrating sieve devices can be arranged in a continuous or non-continuous manner and may be arranged in series or in parallel. Furthermore, conventionally known separating and recovering using a separating and recovering instrument or device, washing using a washing instrument or device, and the like can be used together with the separating and recovering using the vibrating sieve device of the present invention as necessary.

In other words, the polymer separated and recovered by the method of separating and recovering of the present invention may advance to the drying step after a washing step of washing using, for example, water, an alcohol based compound, a ketone based compound, or a polymerization reaction solvent as necessary.

The arrangement position of the vibrating sieve device used in the method of separating and recovering of the present invention is, for example, as follows.

(1) Polymerizing step→separating and recovering using the vibrating sieve device of the present invention→washing step→drying step

(2) Polymerizing step→separating and recovering using the vibrating sieve device of the present invention→separating and recovering using a different separating and recovering instrument or device→washing step→drying step

(3) Polymerizing step→separating and recovering using a different separating and recovering instrument or device→separating and recovering using the vibrating sieve device of the present invention→washing step→drying step

(4) Polymerizing step→separating and recovering using the vibrating sieve device of the present invention→washing step→separating and recovering using a different separating and recovering instrument or device→drying step

(5) Polymerizing step→separating and recovering using a different separating and recovering instrument or device→washing step→separating and recovering using the vibrating sieve device of the present invention→washing step→drying step

(6) Polymerizing step→separating and recovering using the vibrating sieve device of the present invention→washing step→separating and recovering using the vibrating sieve device of the present invention→washing step→drying step

Of these, the arrangement position of the vibrating sieve device used in the method of separating and recovering of the present invention is preferably (1) polymerizing step→separating and recovering using the vibrating sieve device of the present invention→washing step→drying step, or (6) polymerizing step→separating and recovering using the vibrating sieve device of the present invention→washing step→separating and recovering using the vibrating sieve device of the present invention→washing step→drying step.

2-4. Vibrating Sieve Device

The vibrating sieve device used in the method of separating and recovering of the present invention is provided with the resin tapping member for preventing clogging of the screen. In other words, the vibrating sieve device of the present invention is characterized in that the vibrating sieve device always has the resin tapping member for preventing clogging of the screen provided therein. As long as the vibrating sieve device is configured with this feature, the structure, specifications, operating conditions, and the like of the vibrating sieve device are not limited in any manner. Accordingly, the vibrating sieve device of the present invention may be a vibrating sieve device configured with the feature described with structures, specifications, and the like of known separating and recovering instruments and devices incorporated therein. Additionally, it may be a known separating and recovering instrument or device to which the vibrating sieve device of the present invention with the feature described above incorporated therein.

To give a detailed example, the vibrating sieve device of the present invention includes as constituent elements at least a polymer-containing liquid charging port, a screen for separating a polymer from the polymer-containing liquid, resin tapping members for preventing clogging of the screen, a perforated plate for arranging the resin tapping members, a vibration source for imparting vibrations to the screen and the resin tapping members, a polymer discharge port for discharging the polymer separated by the screen to outside the device, and a liquid discharge port for discharging liquid filtrated by the screen outside the device.

The vibrating sieve device of the present invention provided with the constituent elements described above can perform separating and recovering at a high quality, high efficiency, and high processing capacity, which is the object of the present invention.

In a preferable aspect of the vibrating sieve device of the present invention, the resin tapping members are disposed between the screen and the perforated plate disposed below the screen. The vibrations of such a vibrating sieve device cause the resin tapping members to tap, thus preventing clogging of the screen.

In a more preferable aspect of the vibrating sieve device, the vibrating sieve device includes as constituent elements at least the polymer-containing liquid charging port, the screen for separating a polymer from the polymer-containing liquid, the resin tapping members for preventing clogging of the screen, the perforated plate for arranging the resin tapping members, a divider disposed on the perforated plate, the vibration source for imparting vibrations to the screen and the resin tapping members, the polymer discharge port for discharging the polymer separated by the screen to outside the device, and the liquid discharge port for discharging liquid filtrated by the screen outside the device. The resin tapping members are disposed between the screen and the perforated plate disposed below the screen, and vibrations of the vibrating sieve device cause the resin tapping members to tap, thus preventing clogging of the screen.

Examples of the vibrating sieve device include an inclined screen surface vibrating sieve device, a horizontal screen surface vibrating sieve device, a circular screen surface vibrating sieve device (hereinafter abbreviated as circular vibrating sieve device), and the like.

Typically, screening using a screen with sieve openings of approximately 100 μm to 10 mm is widely used in screening using an inclined screen surface vibrating sieve device or a horizontal screen surface vibrating sieve device. Typically, screening using a screen with sieve openings of approximately 20 m to 1 mm is widely used in screening using a circular vibrating sieve device. The vibrating sieve device can be selected in accordance with the particle size and the like of the obtained polymer.

Examples of the vibration source for producing screen vibrations include a single shaft unbalanced weight drive unit, a dual shaft unbalanced weight drive unit, a resonance drive unit, a dual vibration motor drive unit, an electromagnetic vibration drive unit, and the like. The vibration source provided in the vibrating sieve device of the present invention is preferably a vibration source producing vibration components not just in the horizontal and vertical direction but in three dimensions. In such a case, the dispersibility of the supplied material and the ability for particles to pass through the screen is high.

The circular vibrating sieve device employed typically uses a single shaft unbalanced weight drive unit to produce three dimensional vibrations equivalent to a combination of vibration components in the horizontal and vertical direction.

Accordingly, for separating and recovering a polymer from a polymer-containing liquid during or after a polymerization reaction by screening using a vibrating sieve device, the vibrating sieve device is preferably the circular vibrating sieve device.

Additionally, when the particle size of the obtained granules or particles are limited to a specific numerical range having an upper limit and a lower limit, the screen has two stages, the lower stage of the screen having sieve openings of the particle size lower limit and the upper stage having sieve openings of the particle size upper limit. Accordingly, particles passed through the upper stage screen and blocked by the lower stage screen can be obtained.

Note that using a vibrating sieve device with a specific resin tapping member to separate and recover a polymer from the polymer-containing liquid during or after a polymerization reaction by screening is not known in the art.

2-4-1. Circular Vibrating Sieve Device

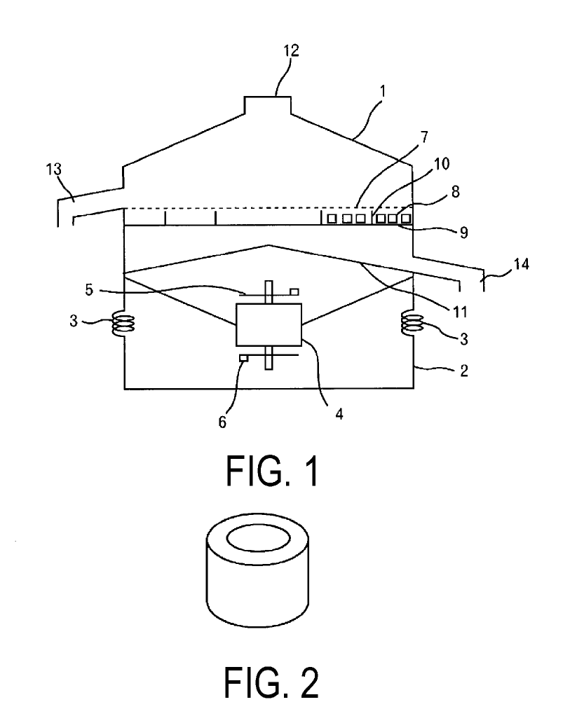

A detailed example of the circular vibrating sieve device as the vibrating sieve device according to the present invention is explained with reference to FIG. 1.

The circular vibrating sieve device includes a body 2. A vibrating member 1 is disposed on the body 2 supported by a coil spring 3. The vibrating member 1 is tubular and includes a bottom portion. In the bottom portion, a drive source 4 is provided. An upper portion and a lower portion of a rotation shaft sharing the same core are vertically coupled to the drive source 4. On the upper portion, an upper portion unbalanced weight 5 is attached, and on the lower portion, a lower portion unbalanced weight 6 is provided.

The vibrating member 1 includes a polymer-containing liquid charging port 12 in an upper central portion, a polymer-containing liquid discharge port 13 on a middle side wall portion, and a liquid discharge port 14 on a lower side wall. In the vibrating member, in order from the top, a screen 7, a perforated plate 9, and a liquid recovery plate 11 are horizontally disposed in the middle portion. The liquid recovery plate 11 is a conical shape so that liquid runs from the central portion to the periphery. The polymer discharge port 13 is disposed in contact with the upper surface of the screen 7 in a manner allowing the polymer on the screen to be discharged out of the device.

The perforated plate 9 is disposed adjacent to the screen 7, that is, disposed with a clearance that allows the resin tapping members 8 to tap. On the perforated plate 9, a divider 10 is disposed in a circular manner that prevents uneven distribution of the resin tapping members 8 caused by vibrations. The divider 10 has a height that approximately reaches the screen 7.

The liquid discharge port 14 is disposed in contact with the upper surface of the liquid recovery plate 11 in a manner allowing the liquid on the liquid recovery plate 11 to be discharged out of the device.

When the upper portion and the lower portion of the rotation shaft rotates, the upper portion unbalanced weight 5 causes horizontal vibrations in the screen 7 and the polymers, i.e. polymer particles, separated from the polymer-containing liquid remaining on the screen are moved in the circumferential direction; and the lower portion unbalanced weight 6 causes vertical vibrations in the screen 7 and the polymers, i.e. polymer particles, separated from the polymer-containing liquid remaining on the screen are moved in the circumferentially outward direction.

The combination of these vibrations produces complex three dimensional vibrations in the screen. By adjusting the phase between the upper portion unbalanced weight 5 and the lower portion unbalanced weight 6, suitable vibrations in the screen 7 are obtained.

Vibrations in the circular vibrating sieve device cause the polymer on the screen to be sequentially and continuously discharged from the polymer discharge port. Thus, using the circular vibrating sieve device, rapid processing of large volumes of the polymer-containing liquid during or after a polymerization reaction is possible.

2-4-2. Screen

In screening using the vibrating sieve device, the screen is an important member that separates what passes through the screen and what does not by being a boundary that allows polymers, i.e. polymer particles, of a fixed particle size to pass therethrough.

In the wire that forms the screen, metal wire such as fine stainless steel wire, synthetic resin fiber (monofilament or multifilament), and the like can be used. Additionally, the weave of the screen may be a plain weave, and the like.

Typically, with the same sieve openings, a thinner screen wire size results in less clogging. However, thinner wires cause durability problems in the screen.

In the circular vibrating sieve device, the screen typically has a diameter of from 0.5 to 2.5 m, preferably from 0.6 to 2.0 m, and more preferably from 0.7 to 1.5 m. When the screen has an excessively small diameter, the amount able to be processed decreases. When the screen has an excessively large diameter, the vibrations travel non-uniformly.

2-4-3. Perforated Plate

In the perforated plate provided below the screen, a stainless steel or similar metal plate with punched holes can be used. A stainless steel or similar metal screen may also be used in some cases. In the circular vibrating sieve device, when the screen has a diameter of from 0.5 to 2.5 m, holes with a diameter of approximately 8 to 15 mm are preferably formed in a staggered pattern by punching so that the opening ratio is approximately 55 to 75%. When the opening ratio of the holes opened in the perforated plate is in this range, the solvent filtrated from the polymer-containing liquid can be easily discharged from the liquid discharge port to outside of the vibrating sieve device, and thus the processing capacity can be increased.

The size, shape, and the like of the holes opened in the perforated plate can vary depending on the size, shape, and the like of the resin tapping members.

On the perforated plate, a divider may be disposed that prevents uneven distribution of the resin tapping members caused by vibrations. The divider may be made of the same metal as the perforated plate or a different metal, or may be made of plastic, and the like. In the case of a circular vibrating sieve device, a plurality of concentric circular dividers are preferably disposed. The height of the divider can be appropriately set depending on the interval between the screen and the perforated plate, the height of the resin tapping members, the concentration of the polymer-containing liquid, the charging speed of the polymer-containing liquid, and the like.

The height of the divider is preferably from 10 to 40% of the interval between the screen and the perforated plate, more preferably from 15 to 35%, and even more preferably from 17 to 33%.

3. Resin Tapping Member

The resin tapping member of the present invention is a resin tapping member that includes a specific resin and is disposed to prevent clogging of the screen. The resin tapping members are disposed at an appropriate density between the perforated plate and the screen of the vibrating sieve device, and more specifically, between the screen and the perforated plate divided by the divider.

3-1. Resin Tapping Member Material

(1) Resin

The resin tapping member of the present invention includes a specific resin. For use in separating and recovering a polymer from a polymer-containing liquid during or after a polymerization reaction by screening, it is important that the resin tapping member has the desirable characteristics of heat resistance, chemical resistance, and wear resistance. Heat resistance can be determined by thermal characteristics such as melting point, glass transition temperature (heat distortion temperature), melt crystallization temperature, and the like. Chemical resistance and wear resistance can be determined by known resin characteristics. Additionally, because the resin tapping members impart shock to the screen by tapping as described above, a certain hardness is demanded. A certain softness is also demanded so that the screen is not damaged.

As the basic characteristics of the resin that forms the resin tapping member, the melting point or heat distortion temperature may be from 120 to 400° C., preferably from 150 to 380° C., more preferably from 200 to 370° C., and even more preferably from 250 to 360° C. Such a resin is suitable in terms of wear resistance and resistance to deformation. A resin with a melting point above 400° C. can be used, however problems in molding processability limits the usage thereof

The resin has a specific gravity typically from 0.8 to 1.9, preferably from 0.9 to 1.85, more preferably from 0.95 to 1.8, and even more preferably from 0.97 to 1.7. An excessively high specific gravity is not preferable as it can cause the screen to break or other damage due to the shock between tapping members. A low specific gravity results in a reduced tapping effect and, when the tapping members are tubular or cylindrical, they become susceptible to overturning.

The present inventors carried out diligent research into the resin tapping member from the perspective of the characteristics described above and found that the resin tapping member preferably includes at least one resin selected from the group consisting of polyamide, polyimide, polyether ether ketone, polymethylpentene, high density polyethylene, ultra high molecular weight polyethylene, polypropylene, and polyarylene sulfide.

Of these, the resin tapping member preferably includes at least one resin selected from the group consisting of polyether ether ketone, polymethylpentene, polypropylene, and polyarylene sulfide.

Polyamide (hereinafter abbreviated as “PA”) is a polymer with an amide bond in the polymer backbone. The melting point is approximately 120 to 260° C. The specific gravity is approximately 1.14.

Polyimide (hereinafter abbreviated as “PI”) is a polymer with an imide bond in the polymer backbone. A thermoplastic polyimide has a heat distortion temperature of approximately 250° C.

Polyether ether ketone (hereinafter abbreviated as “PEEK”) is a crystalline thermoplastic resin which has ether, ether, and ketone bonds in that order in the polymer backbone. The melting point is approximately 330° C. The specific gravity is approximately 1.30.

Polymethylpentene (hereinafter abbreviated as “PMT”) is a thermoplastic resin obtained by polymerizing 4-methylpentene-1. The melting point is approximately 220 to 240° C.

High density polyethylene (hereinafter abbreviated as “HDPE”) is a polyethylene with a density of 0.942 g/cm³ or greater, and preferably 0.96 g/cm³ or greater. The melting point is approximately 120 to 140° C. The specific gravity is approximately 0.95.

Ultra high molecular weight polyethylene (hereinafter abbreviated as “UHPE”) is a polyethylene with a molecular weight of 1,000,000 or greater, and preferably from 1,000,000 to 9,000,000. The melting point is approximately 128 to 136° C.

Polypropylene (hereinafter abbreviated as “PP”) has a melting point of approximately 135 to 165° C. The specific gravity is approximately 0.90 to 0.91.

PAS, specifically PPS, has a melting point of approximately 280° C. and a specific gravity of approximately 1.33. Additionally, in the present invention, a polymer with sulfur in the polymer backbone such as PPS, polyketone sulfide, polyketone ketone sulfide, PAS-polyketone sulfide block polymer, polysulfone, polyether sulfone, and the like is contained in the PAS.

The resin tapping member and the polymer separated and recovered from the polymer-containing liquid are preferably of the same material because, for example, there is less chance of the product, i.e. polymer becoming impure due to tapping, i.e. the resin tapping members wearing or breaking during separating and recovering and these worn off or broken off parts of the resin tapping members contaminating the polymer.

Accordingly, for example, in separating and recovering from a polymer-containing liquid containing PAS, the resin tapping member employed preferably includes PAS, specifically PPS. For screening at high temperatures in the presence of a strong alkali, the resin tapping members preferably include PPS.

(2) Other Components

The resin tapping member of the present invention includes a specific resin. The resin tapping member preferably includes no other components if possible. However, other components such as a filler, other polymer material, and other additives can be added in a range that does not inhibit the object of the present invention.

In such cases, examples of fillers that can be used include fillers in a fibrous, granule, or powder form such as inorganic fibrous substances, metal fibrous substances, and organic fibrous substances made of a high melting point resin. Such fillers can be used individually or two or more can be used together.

Examples of other polymer materials include polymer materials other than the resin described above, and thermoplastic resins stable at high temperatures may be added. The amount of polymer materials other than the resin that forms the resin tapping members of the present invention is, per 100 parts by weight of the resin, typically 10 parts by weight or less. Additionally, various other additives can be added.

The specific resin that forms the resin tapping member has a high melting point or a heat distortion temperature. When the specific gravity is great, there is little benefit gained by adding fillers or other polymer material, and thus these are preferably not added. For example, in the case of PAS being separated and recovered from a polymer-containing liquid containing PAS, when PPS is used as the resin of the resin tapping member, such components are preferably not added.

3-2. Resin Tapping Member Form

The resin tapping member of the present invention can have any form including that of a cube, a rectangular parallelepiped, a plate, a cylinder, a tube, a donut, a cone, and a sphere. In the case of a tube, its form is the same as that of cylinder with a through hole provided in the axial direction. The donut is the form of a cylinder formed into a circle. Donut and spherical forms have no protruding portions and thus are resistant to wear. In the case of the polymer contained in the polymer-containing liquid being granule PAS, the particle form may be uneven. Thus, resin tapping members with the form of a plate, cylinder, or tube are effective at preventing clogging due to an edge effect. Of these, a tubular form is preferable from the perspective of efficiency and operability when separating and recovering.

When the screen used has a diameter of 0.5 to 2.5 m, the resin tapping member in the form of a plate typically has, for example, a length of 20 to 80 mm, a width of 30 to 100 mm, and a height of 10 to 50 mm, preferably a length of 25 to 70 mm, a width of 35 to 85 mm, and a height of 12 to 40 mm, and more preferably a length of 30 to 60 mm, a width of 40 to 80 mm, and a height of 15 to 35 mm.

The resin tapping member in the form of a sphere typically has a diameter of 20 to 70 mm, preferably a diameter of 25 to 60 mm, and more preferably a diameter of 30 to 55 mm.

The resin tapping member in the form of a tube typically has an outer diameter of 20 to 100 mm, an inner diameter of 19 to 99 mm, a height of 10 to 150 mm, and a thickness of 0.5 to 20 mm; preferably an outer diameter of 25 to 90 mm, an inner diameter of 24 to 89 mm, a height of 12 to 100 mm, and a thickness of 0.75 to 17 mm; more preferably an outer diameter of 30 to 80 mm, an inner diameter of 29 to 79 mm, a height of 15 to 85 mm, and a thickness of 1.0 to 15 mm; and even more preferably an outer diameter of 35 to 70 mm, an inner diameter of 34 to 69 mm, a height of 17 to 70 mm, and a thickness of 1.2 to 10 mm. The ratio of the height to the outer diameter is typically 0.1 to 1.5, preferably 0.2 to 1.3, and more preferably from 0.25 to 1.2. If the ratio is too low, the efficiency of the tapping decreases, and if too high, the tapping members become susceptible to overturning.

Additionally, the resin tapping member may be solid or hollow.

Furthermore, the resin tapping member may have a through hole. The through hole is preferably provided as it facilitates the flow of the liquid obtained by screening the polymer-containing liquid using the screen. A plurality of the through holes may be provided. A tubular tapping member can be made by providing a through hole through the cylindrical axis of a cylindrical tapping member.

The size of the resin tapping member, in particular the height and lateral cross-section size of the resin tapping member can be determined as appropriate depending on the interval between the screen and the perforated plate, the area of the screen, and the like.

In other words, the height and lateral cross-section size should allow for suitable tapping by the resin tapping member actuated by vibrations.

When the height of the resin tapping member is H and the interval between the screen and the perforated plate is K, (K−H)/H is typically from 0.1 to 1, preferably from 0.12 to 0.8, more preferably from 0.13 to 0.7, and even more preferably from 0.15 to 0.5.

A smaller interval between the upper end of the disposed resin tapping member and the screen results in a reduced tapping effect. A larger interval results in the resin tapping member being susceptible to overturning. For example, in the case of a tubular tapping member, if the height of the tube is too low compared to the interval between the screen and the perforated plate, the tube may overturn, causing liquid to build up around it and subsequently causing a rapid decrease in the amount of liquid screened. The overturning of the tapping member also depends upon the height and area of the bottom surface of the tapping member, the concentration of the polymer-containing liquid, charging rate, and the like.

For screening, a tubular resin tapping member allows liquid to pass through the central opening thereof. Thus, compared to a spherical or plate resin tapping member when disposed in the same amount, the tubular resin tapping member facilitates the discharge of solvent out of the vibrating sieve device and thus can increase the processing volume when separating and recovering.

FIG. 2 illustrates the resin tapping member in the form of a tube.

The density at which the resin tapping members are disposed depends upon the interval between the screen and the perforated plate, the interval between resin tapping members, and the size of the resin tapping member. Typically the total lateral cross-sectional area of the resin tapping members is from 10 to 90% of the area of the screen, preferably from 20 to 80%, and more preferably from 30 to 70%. When the resin tapping member has the form of a plate, the members are arranged to maximize the lateral cross-sectional area. When the resin tapping member has a through hole, the through hole is preferably provided vertically in relation to the screen surface. Specifically, when the resin tapping member has the form of a tube, the resin tapping member is disposed with the opening thereof facing the screen surface.

3-3. Weight Reduction Percentage, Tensile Strength Retention Percentage, and Height Reduction Amount

The resin tapping member of the present invention has excellent heat resistance, chemical resistance, wear resistance, hardness, and other similar characteristics. Using the vibrating sieve device provided with the resin tapping members of the present invention, the resin tapping member can be determined to have these characteristics by measuring the indicator, either of the weight reduction percentage of the tapping member and the tensile strength retention percentage of the tapping member. The weight reduction percentage is measured after separating and recovering being performed on the polymer-containing liquid continuously for a certain period of time. The tensile strength retention percentage corresponds to the tensile strength retention percentage of a sample formed using the resin that forms the resin tapping member after being immersed in a liquid chemical for a certain period of time. In cases where separating and recovering is performed continuously for a certain period of time, the sum of the time spend intermittently separating and recovering is understood as the certain period of time.

Specifically, the resin tapping member of the present invention typically has a weight reduction percentage after separating and recovering a polymer from a polymer-containing liquid continuously for 48 hours of 3 wt. % or less, preferably 2 wt. % or less, more preferably 1.5 wt. % or less, and even more preferably 1 wt. % or less. Additionally, depending on the resin contained in the resin tapping member and polymer contained in the polymer-containing liquid, the weight reduction percentage after separating and recovering a polymer from a polymer-containing liquid continuously for 48 hours is 0.8 wt. % or less, preferably 0.5 wt. % or less, more preferably 0.2 wt. % or less, even more preferably 0.1 wt. % or less, and most preferably 0 wt. %. A weight reduction percentage of greater than 3 wt. % results in considerable damage to the resin tapping member caused by shock or friction. This causes the resin tapping member to be unsuitable for separating and recovering for extended periods of time and also greatly affects how much the product is contaminated.

For the resin tapping member of the present invention, a sample of the resin that forms the resin tapping member has a tensile strength retention percentage after being immersed for 1000 hours of typically 98% or greater, preferably 98.5% or greater, more preferably 99.0% or greater, even more preferably 99.5% or greater, yet even more preferably 99.7% or greater, and most preferably 100%.

The tensile strength retention percentage is a value obtained by finding the difference between the tensile strength values of a dumbbell shaped sample before and after immersion for 1000 hours in a liquid chemical. The liquid chemical can be selected appropriately taken into consideration the components of the resin and polymer-containing liquid contained in the resin tapping member. Examples include an 80° C. 10 wt. % HCl aqueous solution, an 80° C. 10 wt. % NaOH aqueous solution, an 80° C. 50 wt. % NaOH aqueous solution, a 40° C. acetone, and the like.

Additionally, in the case where the resin tapping member of the present invention has the form of a tube, the height reduction amount after performing separating and recovering on the polymer-containing liquid continuously for 200 hours is typically 2.0 mm or less, preferably 1.5 mm or less, more preferably 1.0 mm or less, even more preferably 0.8 mm or less, yet even more preferably 0.7 mm or less, and most preferably 0 mm.

3-4. Manufacture of Resin Tapping Member

The resin tapping member is manufactured with molding equipment and a method for molding thermoplastic resins. Specific examples of the method include (a) mixing together the resin and other components as necessary, kneading the mixture using a single or double screw extruder, pelletizing the extruded mixture for molding, injection molding or extrusion molding the pellets; and (b) mixing together the resin and other components added as necessary, then injection molding or extrusion molding the mixture.

When the resin tapping member is manufactured by extrusion molding, a method such as one of the following methods is employed: (i) first, a plate or rod is manufactured by extrusion molding, then the plate or rod is cut to obtain the resin tapping member; (ii) a pipe-like molded article is manufactured by extrusion molding, then the pipe-like molded article is cut into rings to obtain the resin tapping member. When the resin tapping member is manufactured by injection molding, a method such as the following method is employed: (iii) injection molding is performed using a mold with the form of the resin tapping member.

### Working Examples

The present invention will be described further in detail using working examples, but the present invention is not limited to these working examples.

(1) Average Particle Size

The average particle size was measured in accordance with JIS K-0069 by placing nine sieves in a vertical stack and placing the polymer sample on the top sieve. The sieves in a vertically ascending order have a 200 mesh (sieve opening 75 μm), 150 mesh (sieve opening 106 μm), 100 mesh (sieve opening 150 μm), 60 mesh (sieve opening 250 μm), 32 mesh (sieve opening 500 μm), 24 mesh (sieve opening 710 μm), 16 mesh (sieve opening 1000 μm), 12 mesh (sieve opening 1400 μm), and 7 mesh (sieve opening 2830 μm).

(2) Weight Reduction Percentage

The weight reduction percentage of the resin tapping members of the working examples and comparative examples was measured using a test circular vibrating device with a diameter of ⅕-scale of the circular vibrating device used in the working examples and comparative examples (the screen, perforated plate, resin tapping members are configured in the same manner in the working examples and the comparative examples). Separating and recovering was performed on the 80° C. polymer-containing liquid continuously for 48 hours while varying the processing rate between 5 to 500 kg per hour (the average processing rate being 30 kg per hour). The sum of the weight of three resin tapping members prior to separating and recovering processing was divided by three to find the weight of one member. This weight and the weight after 48 hours were used to find the weight reduction percentage.

(3) Tensile Strength Retention Percentage

The tensile strength retention percentage was measured in accordance with ASTM D-638. A test dumbbell shaped sample made of the resin used in the resin tapping member was immersed for 1000 hours in a liquid chemical, and the initial tensile strength and the tensile strength after 1000 hours were compared to find the tensile strength retention percentage.

(4) Height Reduction Amount

The height reduction amount was measured as the height reduction amount of the resin tapping member after a total of 200 hours of separating and recovering.

(5) pH Measurement

The liquid was diluted with water by a factor of 10, and measured at room temperature using a pH meter.

### Production Example 1

### Manufacture of PPS

(1) Dehydration Step

2000 g of a 61.8 wt. % NaSH aqueous solution, found by iodiometric analysis, (22.05 mol of NaSH), 1171 g of a 73.7 wt. % NaOH aqueous solution (21.58 mol of NaOH) was added to a reactor with 6001 g of NMP.

After substituting the inside of the reactor with nitrogen gas, the temperature was steadily raised to 200° C. over a period of approximately 4 hours while the contents in the reactor was being stirred, resulting in the distillation of 1014 g of water and 763 g of NMP. At this time, 5.5 g of H₂S (0.16 mol) escaped (volatilized). Accordingly, the available amount of S in the reactor after the dehydration step was 21.89 mol.

(2) Preparing Step

After the dehydration step, the contents in the reactor containing 21.89 mol of the available S were cooled to 150° C. Thereafter, 3283 g of pDCB (pDCB/available S=1.020 (mol/mol)), 2760 g of NMP (added to make NMP in reactor/available S=365 (g/mol)), and 189 g of water (added to make total water amount in reactor/available S=1.62 (mol/mol)) were added, then 43.0 g of NaOH was added to make NaOH in reactor/available S=1.050 (mol/mol). NaOH (0.32 mol) produced by the volatilization of H₂S is contained in the reactor.

(3) Polymerizing Step

First stage polymerizing was performed by letting the reaction in the reactor continue for 5 hours at a temperature of 220° C. while stirring the contents with a stirrer attached to the reactor at 250 rpm. Next, second stage polymerizing was performed by increasing the stirring rate to 400 rpm, and after adding 397 g of water, raising the temperature to 255° C. and letting the reaction continue for 5 hours. Water/available S (mol/mol) was 2.63.

The pH of the polymer-containing liquid was 10.3.

Additionally, this procedure was scaled up to prepare the amount of PPS-containing liquid (polymer-containing liquid) required for the working examples and the comparative examples.

### Production Example 2

### Manufacture of Resin Tapping Members A, B

PPS (Fortron KPS produced by Kureha Corporation, melt viscosity of 480 Pas at 310° C. and a shear rate of 1200/sec) was charged in a Henschel mixer and stirred. The obtained mixed contents were dried, then supplied to a temperature-adjusted dual screw extruder to produce pellets.

An outside mandrel is attached to the die of a single screw extruder, then the cylinder temperature is set to from 250 to 330° C. and the pellets are passed through the extruder. The pellets are extruded with the screw rate set to 15 rpm. The extrudate is sized while being drawn in the radial direction, and cooled with water to form a pipe. The obtained pipe is cut, thus completing the manufacture of the resin tapping member.

The form of the resin tapping member is tubular as illustrated in FIG. 2.

Two types of the obtained resin tapping member include PPS resin tapping member A (outer diameter 48 mm, inner diameter 42 mm, thickness 3 mm, height 25 mm) and PPS resin tapping member B (outer diameter 48 mm, inner diameter 42 mm, thickness 3 mm, height 47 mm).

### Production Example 3

### Manufacture of Polypropylene Resin Tapping Member C

From a pipe made of polypropylene (PP), PP resin tapping member C was manufactured with the same form as resin tapping member A (outer diameter 48 mm, inner diameter 42 mm, thickness 3 mm, height 25 mm).

Vibrating Sieve Device Used in Working Examples and Comparative Examples

The vibrating sieve device which was used in the working examples and comparative examples was a circular vibrating sieve device with a screen diameter of 0.9 m. The screen was a 100 mesh (sieve opening 150 m) stainless steel screen. The perforated plate was a stainless steel plate provided with holes of a 10 mm diameter at an opening ratio of 65%.

There were two configurations: the interval between the screen and the perforated plate being 32 mm and the height of the divider being 9 mm, and the interval between the screen and the perforated plate being 64 mm and the height of the divider being 14 mm.

Two dividers are disposed as two circles and the resin tapping members are disposed in the resulting 3 divisions. The total lateral cross-sectional area of the resin tapping members is 60% of the screen area.

### Working Example 1

After the polymerization reaction of Production Example 1 was completed, the polymer-containing liquid was cooled to 80° C. and subjected to screening by the circular vibrating sieve device described above. The configuration used was: the interval between the screen and the perforated plate being 32 mm and the height of the divider being 9 mm.

The resin tapping member employed was resin tapping member A manufactured in Production Example 2 (outer diameter 48 mm, inner diameter 42 mm, thickness 3 mm, height 25 mm). Via vibrations, a polymer (PPS) on the screen was sequentially and continuously discharged.

The separated polymer was washed three times with acetone and then washed three times with water. The granular polymer was washed one time in an acetic acid aqueous solution adjusted to a pH of 4, then washed three times with water thus obtaining the washed polymer (washing step). The washed polymer was dried for one day at a temperature of 100° C. (drying step). The average particle size was 533 μm. In such a manner, the manufacturing step was repeated until the total time for screening was 48 hours. After the 48 hours, this resulted in no PPS resin tapping members A being overturned. Additionally, the resin tapping members A had no visually identifiable deformation. The weight reduction percentage of the resin tapping members was 0.0%.

### Working Example 2

After the polymerization reaction of Production Example 1 was completed, the polymer-containing liquid was cooled to 80° C. and subjected to screening by the circular vibrating sieve device described above. The configuration used was: the interval between the screen and the perforated plate being 64 mm and the height of the divider being 14 mm. The resin tapping member employed was resin tapping member B manufactured in Production Example 2 (outer diameter 48 mm, inner diameter 42 mm, thickness 3 mm, height 47 mm).

Via vibrations, a polymer (PPS) on the screen was sequentially and continuously discharged.

As with Working Example 1, after the 48 hours total of screening, this resulted in no PPS resin tapping members B being overturned. Additionally, the resin tapping members B had no visually identifiable deformation. The weight reduction percentage of the resin tapping members was 0.0% after the 48 hours.

### Comparative Example 1

Comparative Example 1 was performed in the same manner as Working Example 1 except that the resin tapping members were not used. In this case, the volume processed by screening over the total 48 hours was substantially less than that of Working Examples 1 and 2.

### Comparative Example 2

Comparative Example 2 was performed in the same manner as Working Example 1 except that a commercially available tapping member made of ethylene-propylene-non-conjugated diene copolymer rubber (EPDM) (rectangle: length 40 mm, width 60 mm, thickness 25 mm) was used instead of the resin tapping member A.

Additionally, the tapping member had visually obvious wear. The recovered PPS was contaminated with eraser-shaped foreign objects. The weight reduction percentage after screening for a total of 48 hours was 22%.

### Comparative Example 3

Comparative Example 3 was performed in the same manner as Working Example 2 except that the PPS resin tapping member A was used instead of the PPS resin tapping member B. In this case, (K−H)/H was 1.56, where H is the height of the resin tapping member and K is the interval between the screen and the perforated plate. After 24 hours, this resulted in 25% of the tapping members being overturned and liquid being built up, causing the screening capacity (processing capacity) to drop dramatically.

### Working Example 3

Working Example 3 was performed in the same manner as Working Example 1 except that a tapping member C made of a widely used PP resin was used instead of the PPS resin tapping member A. Even after a total of 200 hours of screening, this resulted in the height of the resin tapping members being decreased only by 0.7 mm.

### Working Example 4

Working Example 4 was performed in the same manner as Working Example 1 except that a tapping member D made of a widely used PE resin was used instead of the PPS resin tapping member A. After a total of 200 hours of screening, this resulted in the height of the resin tapping members being decreased only by approximately 1 mm. In this case, contamination by PE shavings was found.

### Working Example 5

Dumbbell shaped samples for measurement were manufactured using the PPS used in Production Example 2. The samples were immersed in the liquid chemicals indicated in Table 1 for 1000 hours.

The results are shown in Table 1.

TABLE 1

| | | | Tensile strength | |
|---|---|---|---|---|
| | | Immersion | retention percentage | Visual |
| Liquid chemical | Temperature | time | (%) | appearance |
| 10 wt. % HCl aqueous | 80° C. | 1000 hours | Approximately 100 | No |
| solution | | | | deformation |
| 10 wt. % NaOH aqueous | 80° C. | 1000 hours | Approximately 100 | No |
| solution | | | | deformation |
| 50 wt. % NaOH aqueous | 80° C. | 1000 hours | Approximately 100 | No |
| solution | | | | deformation |
| Water | 80° C. | 1000 hours | 100 | No |
| | | | | deformation |
| Acetone | 40° C. | 1000 hours | Approximately 100 | No |
| | | | | deformation |
| Water | 60° C. | 1000 hours | 100 | No |
| | | | | deformation |

### Working Example 6

Tapping member E made of PEEK in addition to tapping members A, C, D, all common in form, were immersed in a 50° C. 40 wt. % NaOH aqueous solution for 100 hours. Thereafter, the same testing that was performed in Working Example 1 was performed on the tapping members. After a total of 100 hours of screening, usage longevity of each of the tapping members was checked. Tapping members A, C, and E had no visually observable deformations and no changes in strength and the like. A slight reduction in strength was observed in tapping member D.

### Working Example 7

Tapping members A, C, D, and E were immersed in 40° C. acetone for 50 hours. Thereafter, the same testing that was performed in Working Example 1 was performed on the tapping members. After a total of 100 hours of screening, usage longevity of each of the tapping members was checked. Tapping members A and E had no visually observable deformations and no changes in strength and the like. A slight reduction in strength was observed in tapping member C. The strength of tapping member D was reduced by some extent.

Observations

In Comparative Example 1, a resin tapping member was not used. As a result, the screening via a screen was not as favorable as that of Working Examples 1 to 3 with the amount processed over an extended period of time being significantly reduced. In Comparative Example 2, EPDM was used for the tapping member. As a result, wear advanced quickly. Additionally, EPDM contaminated the product. In Comparative Example 3, the value for (K−H)/H, where H is the height of the resin tapping member and K is the interval between the screen and the perforated plate, was outside of the range of the present invention. As a result, the tapping members overturned.

In contrast, Working Examples 1 and 2 were performed at high temperatures, allowing for highly efficient screening without time spent on cooling. Additionally, continuous operation for an extended period of time was possible, large volumes could be processed rapidly. Furthermore, the wear of the PPS resin tapping members was minimal. The results of Working Examples 3 and 4 show that the resin tapping members have superior wear resistant. The results of Working Example 5 show that PPS is suitable as the resin of the resin tapping members even in conditions in the presence of various liquid chemicals. The results of Working Examples 6 and 7 show that the PPS resin tapping member had superior chemical resistance to an NaOH aqueous solution, acetone, and the like.

### INDUSTRIAL APPLICABILITY

The resin tapping member of the present invention is used in separating and recovering a polymer from a polymer-containing liquid during or after a polymerization reaction by screening using a vibrating sieve device. This resin tapping member allows for separating and recovering to be performed at a high quality, high efficiency, and high processing capacity by solving such problems as clogging of the screen when separating and recovering is performed for an extended period of time, and weight reduction of the tapping members and contamination of the product caused by the shock and friction produced between tapping members or between the tapping members and a constituent member of the vibrating sieve device such as the screen.

The resin tapping member of the present invention is particularly useful for separating and recovering PAS particles in PAS manufacturing.

### REFERENCE SIGNS LIST

1 Vibrating member
2 Body
3 Coil spring
4 Drive source
5 Upper portion unbalanced weight
6 Lower portion unbalanced weight
7 Screen
8 Resin tapping member
9 Perforated plate
10 Divider
11 Liquid recovery plate
12 Polymer-containing liquid charging port
13 Polymer discharge port
14 Liquid discharge port

1. A resin tapping member for preventing clogging of a screen used in separating and recovering a polymer obtained by a polymerization reaction in a solvent, the resin tapping member having a weight reduction percentage of 3 wt. % or less after continuous separating and recovering of a polymer from a polymer-containing liquid for 48 hours.

2. The resin tapping member according to claim 1, wherein a sample of resin that forms the resin tapping member has a tensile strength retention percentage of 98% or greater after 1000 hours of immersion in a liquid chemical.

3. The resin tapping member according to claim 1, wherein the resin tapping member includes at least one resin selected from the group consisting of polyamide, polyimide, polyether ether ketone, polymethylpentene, high density polyethylene, ultra high molecular weight polyethylene, polypropylene, and polyarylene sulfide.

4. The resin tapping member according to claim 1, wherein the resin tapping member includes at least one resin selected from the group consisting of polyether ether ketone, polymethylpentene, polypropylene, and polyarylene sulfide.

5. The resin tapping member according to claim 1, wherein the resin tapping member has a form of a cube, a rectangular parallelepiped, a plate, a cylinder, a tube, a donut, a cone, or a sphere.

6. The resin tapping member according to claim 5, wherein the resin tapping member has a form of a tube.

7. A method of separating and recovering a polymer obtained by a polymerization reaction in a solvent, the method comprising the step of:
separating and recovering a polymer from a polymer-containing liquid during or after a polymerization reaction by screening using a vibrating sieve device, wherein the vibrating sieve device includes the resin tapping member for preventing clogging of a screen according to claim 1.

8. The method of separating and recovering according to claim 7, wherein
the polymer contains sulfur in a backbone; and
a temperature of the polymer-containing liquid is from 30 to 230° C. in screening.

9. The method of separating and recovering according to claim 8, wherein the polymer is polyarylene sulfide.

10. A vibrating sieve device for use in the method of separating and recovering according to claim 7, the vibrating sieve device comprising:
a screen;
a perforated plate disposed below the screen; and
a resin tapping member disposed between the screen and the perforated plate; wherein
vibrations of the vibrating sieve device cause the resin tapping member to tap, this tapping preventing clogging of the screen.

11. The vibrating sieve device according to claim 10, wherein (K−H)/H is from 0.1 to 1, where H is a height of the resin tapping member and K is an interval between the screen and the perforated plate.
